(19) United States
(12) Patent Application Publication
(10) Pub. No.: US 2007/0072628 A1
(43) Pub. Date: Mar. 29, 2007

(54) Apparatus and method for providing relay station type information in a multi-hop relay broadband wireless access communication system

(75) Inventors: Hyun-Jeong Kang, Seoul (KR); Pan-Yuh Joo, Seoul (KR); Jung-Je Son, Seongnam-si (KR); Jae-Weon Cho, Suwon-si (KR); Hyoung-Kyu Lim, Seoul (KR); Yeong-Moon Son, Anyang-si (KR); Sung-Jin Lee, Seoul (KR); Mi-Hyun Lee, Seoul (KR); Song-Nam Hong, Seoul (KR); Young-Ho Kim, Suwon-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/523,825

(22) Filed: Sep. 20, 2006

(30) Foreign Application Priority Data
Sep. 28, 2005 (KR) 2005-0090727

(51) Int. Cl. H04Q 7/20

(52) U.S. Cl. 455/458; 370/310

(57) ABSTRACT

An apparatus and method for transmitting relay station (RS) type information in a multi-hop relay cellular communication system are provided. In the RS type information providing method, an RS transmits a message including information about RS's type to an MS. The MS acquires the RS type information from the message and performs an initial connection procedure with the RS based on the RS type information.

### PRIORITY

This application claims priority under 35 U.S.C. § 119 to an application entitled “Apparatus and Method for Providing Relay Station Type Information in a Multi-Hop Relay Broadband Wireless Access Communication System” filed in the Korean Intellectual Property Office on Sep. 28, 2005 and assigned Serial No. 2005-90724, the contents of which are incorporated herein by reference.

### BACKGROUND OF THE INVENTION

1. Field of the Invention

The present invention relates generally to a multi-hop relay Broadband Wireless Access (BWA) communication system and, in particular, to an apparatus and method for providing Relay Station (RS) information to a terminal in a multi-hop relay BWA communication system.

2. Description of the Related Art

Provisioning services with diverse Quality of Service (QoS) levels at about 100 Mbps to users is desired in a future-generation communication system called a 4th Generation (4G) communication system. Particularly, providing high-speed service by ensuring mobility and QoS to a BWA communication system such as Wireless Local Area Network (WLAN) and Wireless Metropolitan Area Network (WMAN) is desired. Such examples of these high speed networks are based on the Institute of Electrical and Electronics Engineers (IEEE) 802.16d and IEEE 802.16e standard.

The IEEE 802.16d and an IEEE 802.16e based communication systems are implemented by applying Orthogonal Frequency Division Multiplexing (OFDM)/Orthogonal Frequency Division Multiple Access (OFDMA) communications scheme to physical channels of the WMAN system. The IEEE 802.16d standard considers only a single-cell structure without regard to the mobility of subscriber stations (SSs). In contrast, the IEEE 802.16e standard supports the SS mobility based upon the IEEE 802.16a communication system. A mobile SS is typically called an MS.

FIG. 1 is a block diagram illustrating the configuration of a conventional IEEE 802.16e communication system.

Referring to FIG. 1, the IEEE 802.16e communication system is configured in a multi-cell structure and includes cells 100 and 150, BSs 110 and 140 for managing the cells 100 and 150, respectively, and a plurality of MSs (e.g., 111, 113, 130, 151, and 153). Signals are transmitted using the OFDM/OFDMA communication scheme between the BSs 110 and 140 and the MSs 111, 113, 130, 151 and 153. The MS 130 exists in a cell boundary area of cells 100 and 150, i.e. in a handover region. When the MS 130 moves to the cell 150 managed by the BS 140 during signal transmission/reception to/from the BS 110, the serving BS of the MS 130 is changed from the BS 110 to the BS 140.

Since signaling is carried out between an MS and a fixed BS via a direct link as illustrated in FIG. 1, a highly reliable radio communication link can be established between them using the IEEE 802.16e communication system. However, due to the fixed locations of BSs, a wireless network cannot be configured with flexibility. As a result, the IEEE 802.16e communication system cannot efficiently provide communication services in a radio environment experiencing a fluctuating traffic distribution and a great change in the number of required calls.

These problems can be solved by applying a multi-hop relay data transmission scheme using fixed RSs, mobile RSs, or general MSs to general cellular wireless communication systems such as the IEEE 802.16e based communication system. The multi-hop relay wireless communication system can advantageously reconfigure a network rapidly according to a communication environmental change and enables efficient operation of the whole wireless network. For example, it can expand cell coverage and increase system capacity. When the channel status between a BS and an MS is bad, an RS can be installed between them so that the resulting establishment of a multi-hop relay through the RS provide a better radio channel between the BS and the MS. Accordingly, the multi-hop relay scheme with RSs placed at cell boundarys having a bad channel status, high-speed data channels can be provided and the cell coverage can be expanded.

A description of a configuration of the multi-hop relay wireless communication system which expands the cell coverage of BSs, will now be provided below.

FIG. 2 is a block diagram illustrating a configuration of a conventional multi-hop relay BWA communication system configured to expand the cell coverage of BSs.

Referring to FIG. 2, the multi-hop relay BWA communication system, which is configured in a multi-cell structure, includes cells 200 and 240, BSs 210 and 250 for managing the cells 200 and 240, respectively, a plurality of MSs 211 and 213 within the coverage area of the cell 200, a plurality of MSs 221 and 223 managed by the BS 210 but located in coverage area 230 of the cell 200 which is outside the physical coverage area of cell 200, an RS 220 for providing a multi-hop relay path between the BS 210 and the MSs 221 and 223 within the coverage area 230, a plurality of MSs 251, 253 and 255 within the coverage area of the cell 240, a plurality of MSs 261 and 263 managed by the BS 250 in coverage area 270 which is outside the physical coverage area of the cell 240, and an RS 260 for providing a multi-hop relay path between the BS 250 and the MSs 261 and 263 within the coverage area 270. Signals are transmitted and received among the BSs 210 and 250, the RSs 220 and 260, and the MSs 211, 213, 221, 223, 251, 253, 255, 261, and 263 using the OFDM/OFDMA communication scheme.

Although the MSs 211 and 213 within the coverage area of the cell 200 and the RS 220 can communicate directly with the BS 210, the MSs 221 and 223 within the coverage area 230 cannot communicate with the BS 210, directly. Therefore, the RS 220 covering the area 230 relays signals between the BS 210 and the MSs 211 and 223. Meanwhile, although the MSs 251, 253, and 255 within the coverage area of the cell 240, and the RS 260 can communicate directly with the BS 250, the MSs 261 and 263 within the coverage area 270 cannot communicate with the BS 250, directly. Therefore, the RS 260 having the coverage area 270 under its control, relays signals between the BS 250 and the MSs 261 and 263.

FIG. 3 is a block diagram illustrating a configuration of a conventional multi-hop relay BWA communication system configured to increase system capacity.

Referring to FIG. 3, the multi-hop relay wireless communication system includes a BS 310, a plurality of MSs 311, 313, 321, 323, 331 and 333, and RSs 320 and 330 for providing multi-hop relay paths between the BS 310 and the MSs (e.g., MSs 321 and 323). Signaling is carried out using the OFDM/OFDMA communication scheme between the BS 310, the RSs 320 and 330, and the MSs 311, 313, 321, 323, 331, and 333. The BS 310 manages a cell 300, the MSs 311, 313, 321, 323, 331, and 333 within the coverage area of the cell 300, and the RSs 320 and 330.

Direct links between the BS 310 and the MSs 321, 323, 331, and 333 close to the boundary of the cell 300 may have low Signal-to-Noise Ratios (SNRs). Accordingly, the RS 320 can relay unicast traffic between the BS 310 and the MSs (e.g., 321 and 323), while the RS 330 can relay unicast traffic between the BS 310 and the MSs (e.g. 331 and 333). That is, the RSs 320 and 330 provide high-speed data transmission paths to the MSs 321, 323, 331 and 333, thereby increasing the effective data rates of the MSs and the system capacity.

In the multi-hop relay BWA communication systems illustrated in FIGS. 2 and 3, the RSs 220, 260, 320 and 330 are infrastructure RSs installed by service providers and are thus known to the BSs 210, 240, and 310, or client RSs acting as SSs or MSs, or as RSs under various circumstances. The RSs 220, 260, 320, and 330 may also be fixed, nomadic (e.g. laptop), or mobile-type MSs.

To communicate with a BS via such various types of RSs, an MS has to perform a connection procedure with the RSs and the connection procedure varies with the types of the RSs. Accordingly, there exists a need for defining a signaling procedure for notifying an MS of the type of an RS with which a connection procedure will be performed in the multi-op relay wireless communication system.

### SUMMARY OF THE INVENTION

An object of the present invention is to substantially solve at least the above problems and/or disadvantages and to provide at least the advantages below. Accordingly, an object of the present invention is to provide an apparatus and method for notifying an MS of the type of an RS which will provide relay communications to the MS in a multi-hop relay BWA communication system.

Another object of the present invention is to provide an apparatus and method for notifying an MS of the types of neighbor RSs in a multi-hop relay BWA communication system.

The above objects are achieved by providing an apparatus and method for RS type information in a multi-hop relay cellular communication system.

According to one aspect of the present invention, in a communication method in a multi-hop relay cellular communication system, an RS transmits a message including information about the RS's type to an MS. The MS acquires the type information of the RS from the message and performs an initial connection procedure with the RS based on the type information of the RS.

According to another aspect of the present invention, in a communication method in a multi-hop relay cellular communication system, a serving station transmits a message including information about types of neighbor RSs managed by the serving station to an MS. The MS acquires the type information of the RSs from the message and performs a handover or a network reentry procedure based on the type information of the RSs.

According to a further aspect of the present invention, in an apparatus for an RS in a multi-hop relay cellular communication system, a message generator generates a message including information about the RS's type, and an interface module converts the message according to a predetermined wireless protocol and transmits the converted message through an antenna.

According to still another aspect of the present invention, in an apparatus for a serving station in a multi-hop relay cellular communication system, a message generator generates a message including information about types of neighbor RSs managed by the serving station, and an interface module converts the message according to a predetermined wireless protocol and transmits the converted message through an antenna.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating the configuration of a conventional IEEE 802.16e communication system;

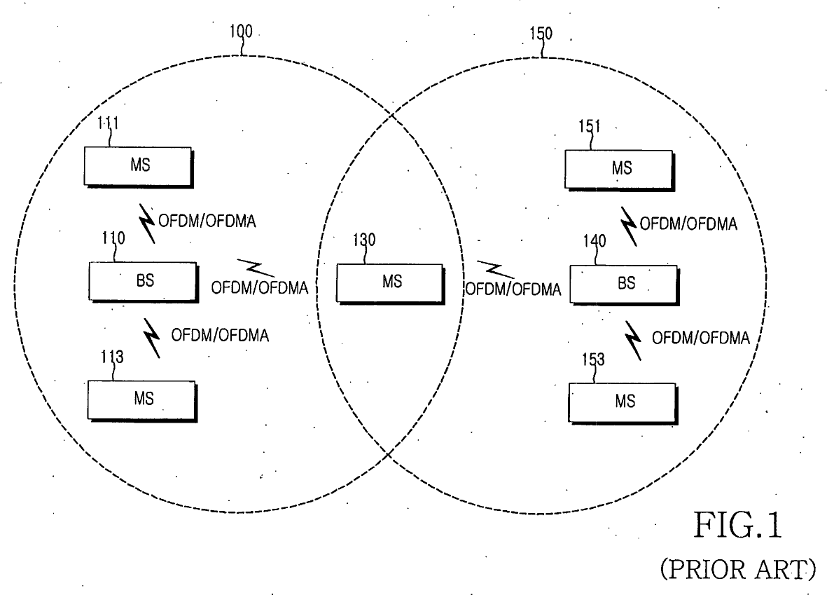

FIG. 2 is a block diagram illustrating a configuration of a conventional multi-hop relay BWA communication system configured to expand the cell coverage of BSs;

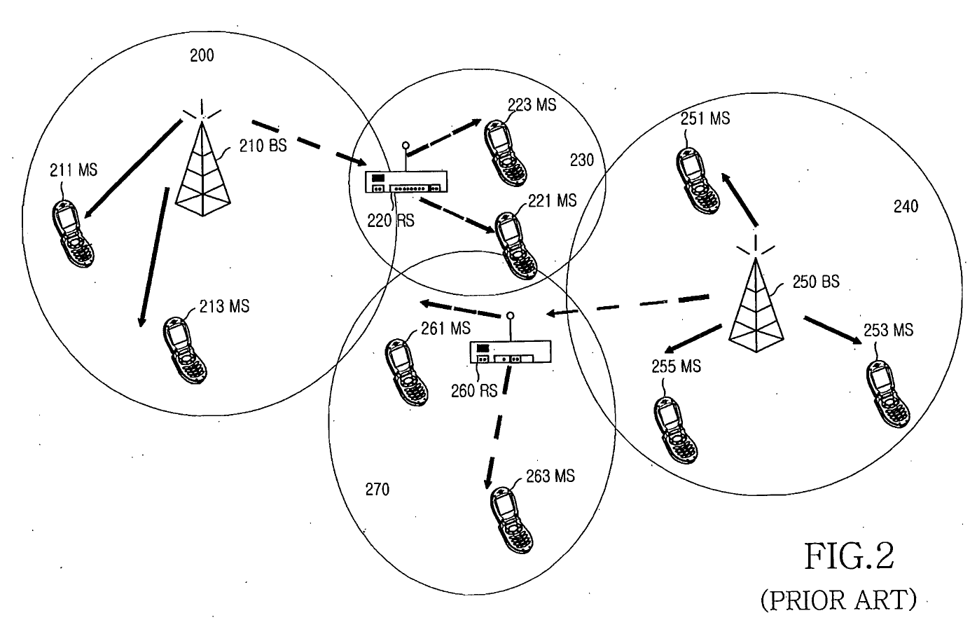

FIG. 3 is a block diagram illustrating a configuration of a conventional multi-hop relay BWA communication system configured to increase system capacity;

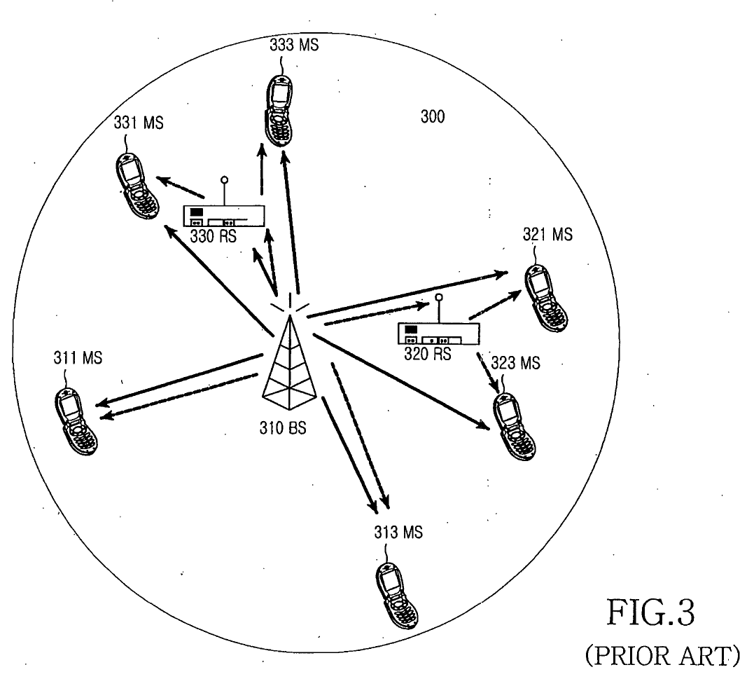

FIG. 4 is a flow diagram illustrating an operation for transmitting RS type information to an MS in a multi-hop relay BWA communication system according to the present invention;

FIG. 5 is a flow diagram illustrating an operation for transmitting RS type information to an MS in the multi-hop relay BWA communication system according to the present invention;

FIG. 6 is a flow diagram illustrating an operation for transmitting RS type information to an MS in the multi-hop relay BWA communication system according to the present invention;

FIG. 7 is a flow diagram illustrating an operation for transmitting RS type information to an MS in the multi-hop relay BWA communication system according to the present invention; and

FIG. 8 is a block diagram illustrating a node in the multi-hop relay BWA communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a signaling procedure for signaling information about a serving and neighbor RS's type to an MS in a multi-hop relay BWA communication system.

The multi-hop relay BWA communication system operates in an OFDM/OFDMA communication scheme, by way of example. As a physical channel signal is delivered on a plurality of subcarriers, the OFDM/OFDMA communication scheme enables high-speed data transmission. Also, the MS's mobility is supported because the multi-hop relay BWA communication system is configured in a multi-cell structure.

While the following description is made in the context of a BWA communication system, it is to be clearly understood that the present invention is applicable to any multi-hop relay cellular communication system.

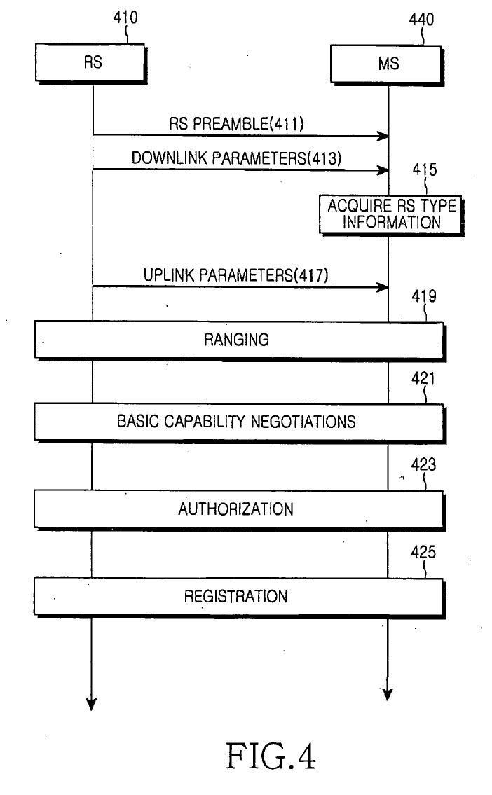

FIG. 4 is a flow diagram illustrating an operation for transmitting RS type information to an MS in a multi-hop relay BWA communication system according to the present invention.

Referring to FIG. 4, upon power-on, an MS 440 determines an RS 410 as its serving station and acquires system synchronization to the RS 410 by receiving a downlink preamble from the RS 410 in step 411. In step 413, the MS 440 then receives a DownLink-MAP (DL-MAP) message and a DownLink Channel Descriptor (DCD) message from the RS 410. The DCD message includes information about downlink channel characteristics and the type of the RS 410.

According to the present invention, RS type encoding information (Type/Value/Length) is configured as shown in Table 1.

TABLE 1

| | Type | Length | |
|---|---|---|---|
| Name | (1 byte) | (bytes) | Value |
| RS | TBD | 1 | Bit 0: infrastructure relay station |
| Type | | | Bit 1: client relay station |
| | | | Bit 2: fixed |
| | | | Bit 3: nomadic |
| | | | Bit 4: mobile |
| | | | Bit 5-7: reserved; shall be set to zero |

Referring to Table 1, the RS type encoding information includes an RS type (RS Type), a To Be Determined (TBD) indicating the type of the encoding, the size of the encoding (Length) (1 byte), and an encoding value (Value). The Value indicates whether the RS 410 is an infrastructure RS installed by a service provider and thus known to a BS, or a client RS being a general SS with the relay function. The client RS can be an MS such as the MS 440 or a fixed SS. The Value also indicates whether the RS 410 is fixed, nomadic, or mobile. The MS 440 identifies the type of the RS 410 by the RS type encoding information and performs an initial connection procedure required for communications with the BS according to the type of the RS 410.

After receiving the DL-MAP and the DCD, the MS 440 acquires information (i.e., parameters) needed for the initial connection procedure from the messages in step 415. That is, the MS 440 acquires the RS type information from the DCD in step 415. The RS type information can be provided to the MS in the DCD message or in a different message.

The MS 440 receives an UpLink Channel Descriptor (UCD) message and an UpLink-MAP (UL-MAP) message and acquires uplink parameters from the UCD in step 417. The UL-MAP includes information about initial ranging opportunity periods. The UCD includes information about uplink channel characteristics and initial ranging-associated parameters.

The MS 440 performs an initial ranging procedure with the RS 410 in step 419 and a basic capability negotiation procedure with the RS 410 in step 421. In step 423, the MS 440 performs an authorization procedure to communicate with the BS via the RS 410. The authorization procedure may vary according to the RS type information, which is beyond the scope of the present invention and thus will not be described in detail. After the authorization, the MS 440 registers to the BS via the RS 410 in step 425.

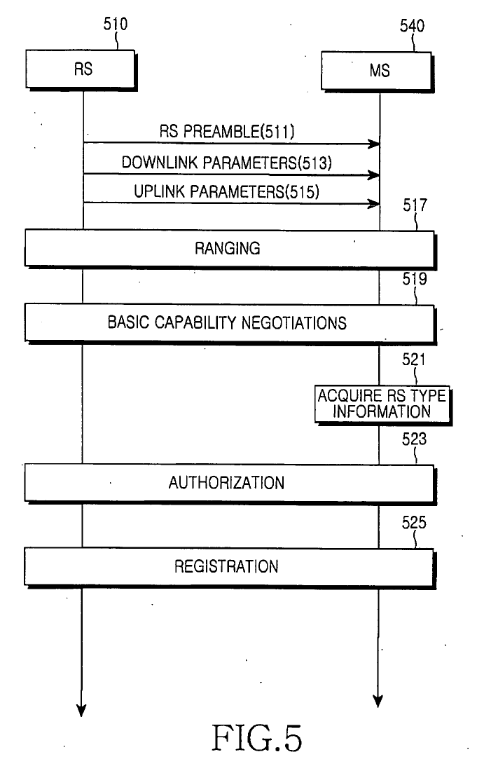

FIG. 5 is a flow diagram illustrating an operation for transmitting RS type information to an MS in the multi-hop relay BWA communication system according to the present invention.

Referring to FIG. 5, upon power-on, an MS 540 determines an RS 510 as its serving station and acquires system synchronization to the RS 510 by receiving a downlink preamble from the RS 510 in step 511. In step 513, the MS 540 then receives a DL-MAP message and a DCD message from the RS 510 and acquires information about downlink channel characteristics from the DCD message.

In step 515, the MS 540 receives a UCD message and a UL-MAP message and acquires information about initial ranging opportunity periods and uplink channel characteristics, and initial ranging-associated parameters from the received messages.

The MS 540 performs an initial ranging procedure with the RS 510 in step 517 and a basic capability negotiation procedure with the RS 510 in step 519. In step 521, the MS 540 acquires RS type information from a basic capability information message received from the RS 510 during the basic capability negotiations. The RS type information has the configuration illustrated in Table 1.

In step 523, the MS 540 performs an authorization procedure to communicate with the BS via the RS 510. The authorization procedure may vary according to the RS type information, which is beyond the scope of the present invention and thus will not be described in detail. After the authorization, the MS 540 registers to the BS via the RS 510 in step 525.

As depicted in FIGS. 4 and 5, the MS acquires the RS type information during the initial connection procedure with the RS. However, the MS may acquire RS type information from a BSserving the MS.

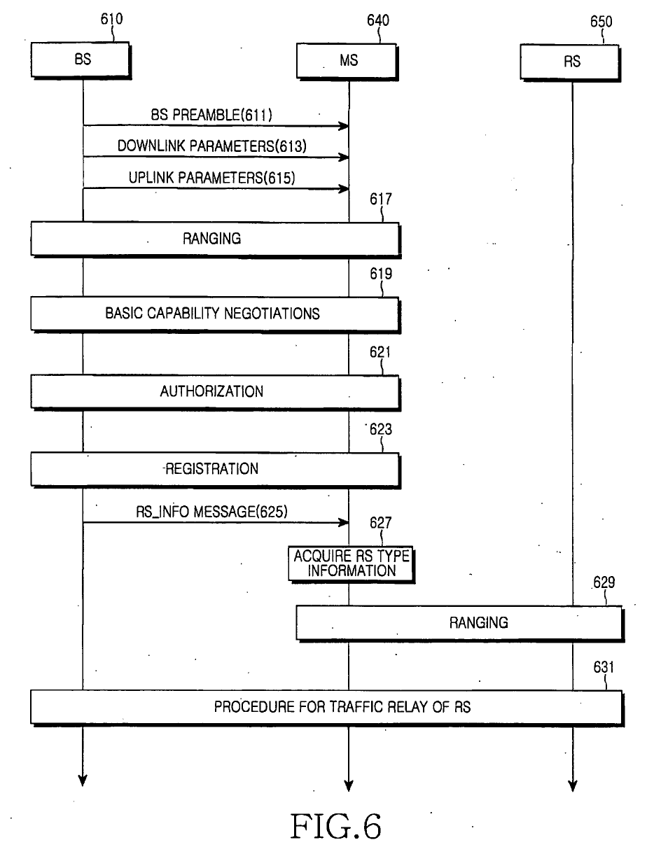

FIG. 6 is a flow diagram illustrating an operation for transmitting RS type information to an MS in the multi-hop relay BWA communication system according to the present invention.

Referring to FIG. 6, upon power-on, an MS 640 determines a BS 610 as a serving station and acquires system synchronization to the BS 610 by receiving a downlink preamble from the BS 610 in step 611. In step 613, the MS 640 receives a DL-MAP message and a DCD message from the BS 610 and acquires information about downlink channel characteristics from the received messages.

In step 615, the MS 640 receives a UCD message and a UL-MAP message from the BS 610 and acquires information about initial ranging opportunity periods and uplink channel characteristics, and initial ranging-associated parameters from the received messages.

The MS 640 performs an initial ranging procedure with the BS 610 in step 617 and a basic capability negotiation procedure with the BS 610 in step 619. In step 621, the MS 640 performs an authorization procedure for communications with the BS 610. After the authorization, the MS 640 registers to the BS 610 in step 623.

After the initial connection procedure, the MS 640 receives a serving cell RS information (RS_INFO) message including information about the types of RSs managed by the BS 610 in step 625, and identifies the types of the RSs from the RS_INFO message in step 627. The RS_INFO message is broadcast to all MSs or unicast to a particular MS within the serving BS coverage.

The RS_INFO message has the following configuration illustrated in Table 2 below.

TABLE 2

| | | Size | |
|---|---|---|---|
| Syntax | | (bits) | Notes |
| RS_INFO_Message_Format( ) { | | | |
| | Management Message | 8 | To be determined |
| Type=TBD | | | |
| | N_RS | 8 | Number of RSs in |

serving cell

For (i=0; i<N_RS; i++) {

| | | |
|---|---|---|
| RS ID | 48 | Identifier of RS |
| RS Type | 8 | RS type information |

Bit 0: infrastructure
relay station
Bit 1: client relay
station
Bit 2: fixed
Bit 3: nomadic
Bit 4: mobile
Bit 5-7: reserved

}

}

Referring to Table 2, the RS_INFO message includes a plurality of Information Elements (IEs). The IEs are Management Message Type indicating the message type of the transmitted message, N_RS indicating the number of RSs includes in the message, RS ID identifying each RS, and RS Type indicating the type of the RS.

The RS Type indicates whether the RS is an infrastructure RS installed by a service provider and thus known to the BS 610, or a client RS being a general SS with the relay function. The client RS can be an MS, such as the MS 640, or a fixed SS. The RS Type may also indicate whether the RS is fixed, nomadic, or mobile. The MS 640 identifies the type of an RS by the RS Type with which a connection procedure will be performed and performs the connection procedure according to the RS type.

The RS_INFO message illustrated in Table 2 may have the same configuration as a Neighbor RS Advertisement message indicating RSs within a serving cell area. The Neighbor RS Advertisement message provides information necessary to acquire synchronization between the MS and the RSs. The Neighbor RS Advertisement message may contain the IDs of the RSs within the serving cell area, preamble information, information for synchronization with the RSs, and information necessary for relay communications via the RSs. Therefore, in the case where the RS_INFO message has the same message structure as the Neighbor RS Advertisement message, the former can be added as a parameter to the latter.

After acquiring the type information of an RS 650 to communicate with, the MS 640 performs a ranging procedure with the RS 650 based on the type information in step 629 and the subsequent procedures required for traffic relay of the RS 650 (i.e., basic capability negotiations, authorization, and/or registration) in step 631.

The MS may acquire RS type information from a serving station (e.g., a BS or RS) during communications with the serving station.

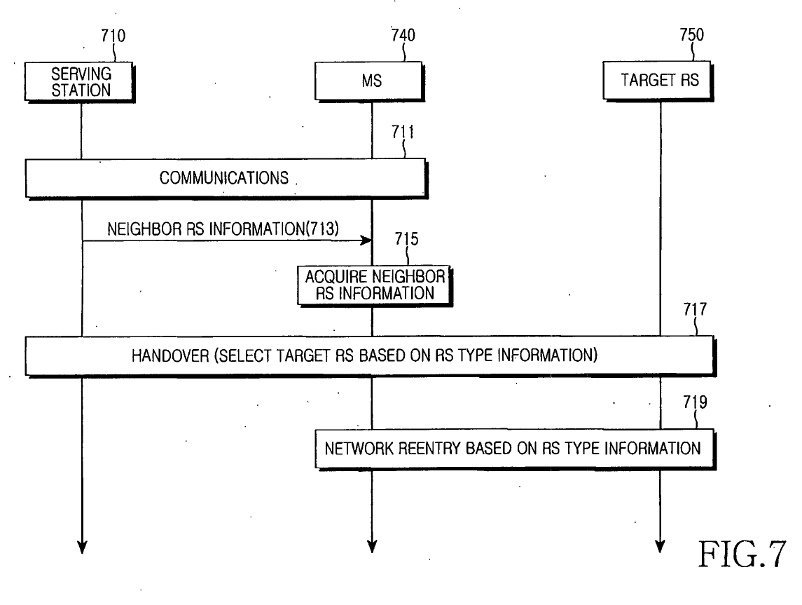

FIG. 7 is a flow diagram illustrating an operation for transmitting RS type information to an MS in the multi-hop relay BWA communication system according to the present invention.

Referring to FIG. 7, an MS 740 communicates with a serving station 710 which can be a BS or an RS in step 711. During the communications, the MS 740 receives a Neighbor RS Advertisement message from the serving station 710 in step 713 and acquires RS type information from the received message in step 715. The RS type information has the structure illustrated in Table 1 and may be included as a parameter in the Neighbor RS Advertisement message.

Meanwhile, the MS 740 can hand over to a neighbor BS or a neighbor RS. In the case of a handover to one of the neighbor RSs included in the Neighbor RS Advertisement message, the MS 740 can select a target RS based on the RS type information. Specifically, if there are a plurality of candidate RSs for handover, the MS 740 selects a target RS by comparing the types of the RSs.

When the handover is required, the MS 740 selects a target RS 750 by comparing the types of the RSs in step 717 and performs a network reentry procedure with the target RS in step 719. During the network reentry, the MS 740 can utilize the type information of the target RS 750. The network reentry based on the type information is beyond the scope of the present invention and will not be described herein in detail.

A description will be made of a block diagram of an MS, an RS, and a BS. Since the MS, the RS and the BS have an identical interface module (communication module), their operations will be jointly described.

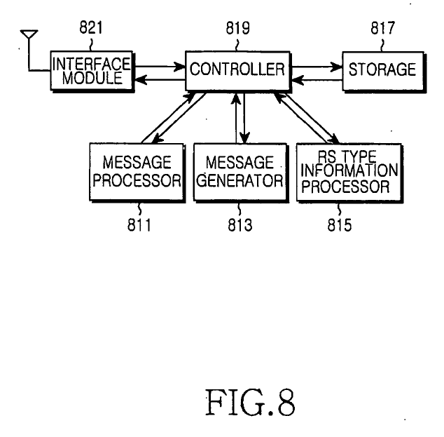

FIG. 8 is a block diagram illustrating the MS (the RS or the BS) according to the present invention. The following description is made mainly of processing a control message.

Referring to FIG. 8, in the MS, an interface module 821, used to communicate with the RS or the BS, includes a Radio Frequency (RF) processor and a baseband processor. The RF processor downconverts a signal received through an antenna to a baseband signal and provides the baseband signal to the baseband processor. For transmission, the RF processor upconverts a baseband signal received from the baseband processor to an RF signal and transmits the RF signal in the air through the antenna. If a BWA scheme is used, the baseband processor Fast Fourier Transform (FFT)-processes the signal received from the RF processor and channel-decodes the FFT signal and provides the resulting original information data to a controller 819. For transmission, the baseband processor channel-encodes and Inverse Fast Fourier Transform (IFFT)-processes data received from the controller 819 and provides the IFFT signal to the RF processor.

The controller 819 provides overall control to the MS. For example, the controller 819 processes and controls voice communication and data communication. In addition to the typical functions, the controller 819 performs an operation associated with RS type information. According to the present invention, the controller 819 provides a control message received from the RS or the BS to a message processor 811, and provides a transmission message for the RS or BS received from a message generator 813 to the interface module 821.

A storage 817 stores programs for controlling the overall operation of the MS and temporary data generated during execution of the programs. That is, the storage 817 can store data and control information that the MS will transmit to the RS or the BS.

The message processor 811 disassembles the control message received from the RS or the BS and notifies the controller 819 of the disassembly result. According to the present invention, upon receipt of a message including RS type information illustrated in Table 1 or Table 2, the message processor 811 extracts control information from the message and provides the control information to the controller 819. The controller 819 then operates correspondingly in accordance with the control information.

An RS type information processor 815 generates information necessary for a communication procedure with the RS by processing the RS type information received form the RS or the BS under the control of the controller 819 and provides the information to the controller 819. The RS type information processor 815 also manages neighbor RS type information received form the RS or the BS.

The message generator 813 generates a message to be transmitted to the RS or the BS under the control of the controller 819 and provides the message to the interface module 821 via the controller 819.

In the above MS's configuration, the controller 819 controls the message processor 811, the message generator 813, and the RS type information processor 815. In other words, the controller 819 can perform the functions of the message processor 811, the message generator 813, and the RS type information processor 815. While the message processor 811, the message generator 813, and the RS type information processor 815 are shown separately in FIG. 8 for illustrative purposes, all or part of their functions may be incorporated into the controller 819.

With reference to FIG. 8, the structure of the RS will be described.

Referring to FIG. 8, in the RS, the interface module 821, is used to communicate with the MS or the BS, and includes the RF processor and the baseband processor. The RF processor downconverts a signal received through an antenna to a baseband signal and provides the baseband signal to the baseband processor. For transmission, the RF processor upconverts a baseband signal received from the baseband processor to an RF signal and wirelessly transmits the RF signal through the antenna. If a BWA scheme is used, the baseband processor FFT-processes the signal received from the RF processor and channel-decodes the FFT signal and provides the resulting original information data to a controller 819. For transmission, the baseband processor channel-encodes and IFFT-processes data received from the controller 819 and provides the IFFT signal to the RF processor.

The controller 819 provides overall control to the RS. For example, the controller 819 processes and controls voice communication and data communication. In addition to the typical functions, the controller 819 performs an operation associated with RS type information. According to the present invention, the controller 819 provides a control message received from the MS or the BS to the message processor 811, and provides a transmission message for the MS or the BS received from the message generator 813 to the interface module 821.

The storage 817 stores programs for controlling the overall operations of the RS and temporary data generated during execution of the programs. That is, the storage 817 can store data and control information that the RS will transmit to the MS or the BS.

The message processor 811 disassembles the control message received from the MS or the BS and notifies the controller 819 of the disassembly result. According to the present invention, upon receipt of a message from the MS or the BS, the message processor 811 extracts control information from the message and provides the control information to the controller 819. The controller 819 then operates correspondingly in accordance with the control information.

The RS type information processor 815 manages MSs under its control and RS type information to be sent to the MSs. That is, the RS type information processor 815 collects information about the type of RS itself and the types of neighbor RSs and broadcasts or unicasts the RS type information.

The message generator 813 generates a message including RS type information illustrated in Table 1 or Table 2 to be transmitted to the MS under the control of the controller 819 and provides the message to the interface module 821 via the controller 819.

In the above RS's configuration, the controller 819 controls the message processor 811, the message generator 813, and the RS type information processor 815. In other words, the controller 819 can perform the functions of the message processor 811, the message generator 813, and the RS type information processor 815. While the message processor 811, the message generator 813, and the RS type information processor 815 are shown separately in FIG. 8 for illustrative purposes, all or part of their functions may be incorporated into the controller 819 in real implementation.

With reference to FIG. 8, the structure of the BS will be described.

Referring to FIG. 8, in the BS, the interface module 821, is used to communicate with the MS or the RS, and includes the RF processor and the baseband processor. The RF processor downconverts a signal received through an antenna to a baseband signal and provides the baseband signal to the baseband processor. For transmission, the RF processor upconverts a baseband signal received from the baseband processor to an RF signal and transmits the RF signal in the air through the antenna. If a BWA scheme is used, the baseband processor FFT-processes the signal received from the RF processor and channel-decodes the FFT signal and provides the resulting original information data to a controller 819. For transmission, the baseband processor channel-encodes and IFFT-processes data received from the controller 819 and provides the IFFT signal to the RF processor.

The controller 819 provides overall control to the BS. For example, the controller 819 processes and controls voice communication and data communication. In addition to the typical functions, the controller 819 performs an operation associated with RS type information for the MS. According to the present invention, the controller 819 provides a control message received from the MS or the RS to the message processor 811, and provides a transmission message for the MS or the RS received from the message generator 813 to the interface module 821.

The storage 817 stores programs for controlling the overall operations of the RS and temporary data generated during execution of the programs. That is, the storage 817 can store data and control information that the BS will transmit to the MS or the RS.

The message processor 811 disassembles the control message received from the MS or the RS and notifies the controller 819 of the disassembly result. According to the present invention, upon receipt of a message from the MS or the RS, the message processor 811 extracts control information from the message and provides the control information to the controller 819. The controller 819 then operates correspondingly in accordance with the control information.

The RS type information processor 815 manages MSs under its control and RS type information to be transmitted to the MSs. That is, the RS type information processor 815 collects information about the types of neighbor RSs and broadcasts or unicasts the neighbor RS type information.

The message generator 813 generates a message to be transmits to the MS or the RS under the control of the controller 819 and provides the message to the controller 819. According to the present invention, the message generator 813 generates a message including RS type information illustrated in Table 1 or Table 2 and provides the message to the interface module 821 via the controller 819.

In the above BS's configuration, the controller 819 controls the message processor 811, the message generator 813, and the RS type information processor 815. In other words, the controller 819 can perform the functions of the message processor 811, the message generator 813, and the RS type information processor 815. While the message processor 811, the message generator 813, and the RS type information processor 815 are shown separately in FIG. 8 for illustrative purposes, all or part of their functions may be incorporated into the controller 819.

In accordance with the present invention as described above, when the channel status of a direct link between an MS and a BS is bad, a multi-hop relay path is established between the MS and the BS via an RS in a multi-hop relay OFDM/OFDMA BWA communication system, so that the same service and functions can be provided via the RS as if the MS and the BS were communicating with each other via the direct link. Furthermore, since the MS is notified of the type of the RS that provides the multi-hop relay path, the MS and the RS can perform an appropriate connection procedure according to the RS type. The RS type information can also be utilized in selecting a target RS by the MS.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A communication method for a Relay Station (RS) in a communication system, comprising the steps of:
generating a message including information about a type of the RS; and
transmitting the message to a Mobile Station (MS).

2. The communication method of claim 1, wherein the type information of the RS indicates at least one of an infrastructure RS, a client RS, a fixed RS, a nomadic RS, and a mobile RS.

3. The communication method of claim 1, wherein the message is configured to deliver a Downlink Channel Descriptor (DCD) to the MS.

4. The communication method of claim 1, wherein the message is configured for basic capability negotiations.

5. A communication method for a serving station in a communication system, comprising the steps of:
generating a message including information about types of neighbor Relay Stations (RSs); and
transmitting the message to a Mobile Station (MS).

6. The communication method of claim 5, wherein the type information of each of the RSs indicates at least one of an infrastructure RS, a client RS, a fixed RS, a nomadic RS, and a mobile RS.

7. The communication method of claim 5, wherein the message is configured to advertise information about the neighbor RSs.

8. The communication method of claim 5, wherein the serving station is one of a Base Station (BS) and a Relay Station (RS).

9. A communication method for a Mobile Station (MS) in a communication system, comprising the steps of:
receiving a message including information about a type of a Relay Station (RS), when the MS is connected to the RS; and
acquiring information about the type of the RS from the message.

10. The communication method of claim 9, further comprising performing an initial connection procedure based on the type information of the RS.

11. The communication method of claim 9, wherein the type information of the RS indicates at least one of an infrastructure RS, a client RS, a fixed RS, a nomadic RS, and a mobile RS.

12. The communication method of claim 9, wherein the message is configured to deliver a Downlink Channel Descriptor (DCD) to the MS.

13. The communication method of claim 9, wherein the message is configured for basic capability negotiations.

14. A communication method for a Mobile Station (MS) in a communication system, comprising the steps of:
receiving a message including information about types of neighbor Relay Stations (RSs); and
acquiring information about the types of the RSs from the message.

15. The communication method of claim 14, wherein the serving station is one of a Base Station (BS) and a Relay Station (RS).

16. The communication method of claim 14, further comprising performing an initial connection procedure based on the type information of the RSs.

17. The communication method of claim 14, further comprising:
selecting a target RS for handover based on the type information of the RSs; and
performing a network reentry procedure based on the type information of the selected target RS.

18. The communication method of claim 14, wherein the type information of each of the RSs indicates at least one of an infrastructure RS, a client RS, a fixed RS, a nomadic RS, and a mobile RS.

19. The communication method of claim 14, wherein the message is configured to advertise information about neighbor RSs.

20. A communication method in a communication system, comprising the steps of:
transmitting, to a Mobile Station (MS), a message including information about a type of a Relay Station by the RS;
acquiring the type information of the RS from the message by the MS; and
performing an initial connection procedure with the RS based on the type information of the RS by the MS.

21. The communication method of claim 20, wherein the type information of the RS indicates at least one of an infrastructure RS, a client RS, a fixed RS, a nomadic RS, and a mobile RS.

22. The communication method of claim 20, wherein the message is configured to deliver a Downlink Channel Descriptor (DCD) to the MS.

23. The communication method of claim 20, wherein the message is configured for basic capability negotiations.

24. A communication method in a communication system, comprising the steps of:
transmitting, by a serving station, to a Mobile Station (MS) a message including information about types of neighbor RSs;
acquiring, by the MS, the type information of the RSs from the message; and
performing, by the MS, a handover or a network reentry procedure based on the type information of the RSs.

25. The communication method of claim 24, wherein the serving station is one of a Base Station (BS) and an RS.

26. The communication method of claim 24, wherein the type information of each of the RSs indicates at least one of an infrastructure RS, a client RS, a fixed RS, a nomadic RS, and a mobile RS.

27. The communication method of claim 24, wherein the message is configured to advertise information about the neighbor RSs.

28. An apparatus for a Relay Station (RS) in a communication system, comprising:
a message generator for generating a message including information about a type of the RS; and
an interface module for converting the message according to a predetermined wireless protocol and transmitting the converted message through an antenna.

29. The apparatus of claim 28, wherein the type information of the RS indicates at least one of an infrastructure RS, a client RS, a fixed RS, a nomadic RS, and a mobile RS.

30. The apparatus of claim 28, wherein the message is configured to deliver a Downlink Channel Descriptor (DCD) to a Mobile Station (MS).

31. The apparatus of claim 28, wherein the message is configured for basic capability negotiations.

32. The apparatus of claim 28, wherein the interface module is used for Orthogonal Frequency Division Multiplexing (OFDM) communication.

33. An apparatus for a serving station in a communication system, comprising:
a message generator for generating a message including information about a type of neighbor RSs; and
an interface module for converting the message according to a predetermined wireless protocol and transmitting the converted message through an antenna.

34. The apparatus of claim 33, wherein the type information of each of the RSs indicates at least one of an infrastructure RS, a client RS, a fixed RS, a nomadic RS, and a mobile RS.

35. The apparatus of claim 33, wherein the message is configured to advertise information about the neighbor RSs.

36. The apparatus method of claim 33, wherein the serving station is one of a Base Station (BS) and a Relay Station (RS).

37. The apparatus of claim 33, wherein the interface module is used for Orthogonal Frequency Division Multiplexing (OFDM) communication.
